(19) United States
(12) Patent Application Publication
(10) Pub. No.: US 2024/0191059 A1
(43) Pub. Date: Jun. 13, 2024

(54) TEREPHTHALATE AND BENZOATE BASED ESTERS AND EPOXIDIZED OIL COMPOSITIONS

(71) Applicant: Eastman Chemical Company, Kingsport, TN (US)

(72) Inventor: Thomas John Markley, Kingsport, TN (US)

(73) Assignee: Eastman Chemical Company, Kingsport, TN (US)

(21) Appl. No.: 18/556,383

(22) PCT Filed: Apr. 13, 2022
(86) PCT No.: PCT/US2022/024509

§ 371 Date: Oct. 20, 2023

Related U.S. Application Data
(60) Provisional application No. 63/201,369, filed on Apr. 27, 2021.

(51) Int. Cl. C08K 5/12; C08J 3/22; C08L 27/06

(52) U.S. Cl. CPC C08K 5/12; C08J 3/226; C08L 27/06; C08J 2391/00; C08L 2205/06; C08L 2207/322; C08L 2310/00

(57) ABSTRACT

The present invention provides a non-phthalate, highly sustainable plasticizer, with performance comparable to or better than the existing orthophthalate market leader (DINP) and non-phthalate market leader (DOTP) at a lower cost position. The novel plasticizers are terephthalate ester and epoxidized oil compositions and dibenzoate ester and epoxidized oil compositions. The novel plasticizer compositions are produced by blending a fast fusing terephthalate diester or dibenzoate ester with an epoxidized oil. The presence of the terephthalate diester or the dibenzoate ester in the blend imparts better physical properties and performance properties over the ester or epoxidized oil components alone.

### FIELD OF THE INVENTION

This application relates to chemistry generally. In particular, this application relates plasticizers, and more particularly to terephthalate and benzoate esters and epoxidized oil compositions and there use as plasticizers.

### BACKGROUND OF THE INVENTION

In a circular economy there is a need for a biobased or sustainable non-phthalate plasticizer. An important performance attribute of any plasticizer is its ability to stay within a polyvinyl chloride (PVC) matrix. Incompatibility with any of the components of a formulation can cause the plasticizer to migrate to the surface of a PVC part, a process known as exudation. Any amount of exudation may lead to a product that is unsatisfactory for the end user. It is also desirable that plasticizers be relatively inexpensive. One example of a relatively inexpensive plasticizer is an epoxidized oil made from soybean oil (ESO) or linseed oil (LSO). These plasticizers however may exhibit some processing difficulties and performance deficiencies. For example, ESO has special storage and handling issues due to its relatively high freezing point compared to other plasticizers. Use of ESO as a primary plasticizer can pose processing difficulties when making PVC materials due to the slow absorption rate of the ESO plasticizer into the PVC resin. ESO also has a relatively high viscosity. Plasticizer viscosity has some impact on dry time of a dry blend. The higher the viscosity, the longer the dry time at a given temperature. The plasticizer viscosity will have an even bigger impact on a plastisol viscosity. Since a plastisol is nothing more than a suspension of solid particles in a liquid phase, the viscosity of the liquid will contribute greatly to the overall viscosity of the plastisol. To eliminate the processing and performance issues associated with ESO requires the addition of fast fusing plasticizers such as dibutyl phthalate (DBP) or Diisobutyl phthalate (DiBP). These orthophthalate plasticizers are either banned or in the process of being banned from use depending on the global region due to health and environmental concerns. Thus a need exists for an inexpensive, non-phthalate plasticizer. In a production environment, where the fate of every last molecule of a substance is being scrutinized, it is now prudent to measure the volatility of the components in a given formulation. Emissions from production stack, volatile organic compounds (VOCs) coming off the production line, and VOCs measured off the final product are but a few of the key spots where the amount of VOCs are being quantified. The ability of a PVC film to maintain its physical properties over time is important. Heat can affect the PVC films ability to maintain its physical properties. Plasticizer can volatilize out of films at elevated temperatures. Typically, lower molecular weight plasticizers tend to volatilize more than higher molecular weight plasticizers.

Therefore a need exists for a non-phthalate, highly sustainable plasticizer, with performance comparable to/better than the existing orthophthalate market leader (DINP) and non-phthalate market leader (DOTP) at a lower cost position.

To solve these issues novel terephthalate ester and epoxidized oil compositions and dibenzoate ester and epoxidized oil compositions have been identified that are effective plasticizers. The novel compositions are produced by blending a fast fusing terephthalate diester or dibenzoate ester with an epoxidized oil. The presence of the terephthalate diester or the dibenzoate ester in the blend imparts better physical properties and performance properties over the two components alone. Addition of a fast fusing plasticizer such as dibutyl terephthalate (DBT) into ESO allows one to maximize the ESO content and use this blend as a primary plasticizer. A polyvinylchloride composition having a polyvinyl chloride resin and a novel plasticizer of terephthalate ester or a dibenzoate ester and epoxidized oil composition have been identified that have improved processing and performance properties.

### SUMMARY OF THE INVENTION

The invention is set forth in the appended claims.

There is now provided a plasticizer composition comprising: a) at least one terephthalate diester of a C₃-C₅ linear or branched alcohol; and b) an epoxidized oil.

In an embodiment of the invention the plasticizer composition the weight ratio of terephthalate diester to epoxidized oil is from 90:10 to 10:90.

In another embodiment of the invention the epoxidized oil has an oxirane content of about 4-10%.

In another embodiment of the invention the epoxidized oil is epoxidized soybean oil, epoxidized linseed oil, epoxidized castor oil, epoxidized palm oil, epoxidized tall oil, epoxidized linoleate, epoxidized oleate, epoxidized stearate, epoxidized propylene glycol dioleate and mixtures thereof.

In another embodiment of the invention the terephthalate diester is, dibutyl terephthalate, diisobutyl terephthalate, dipentyl terephthalate, diisopentyl terephthalate, dipropyl terephthalate, diisopropyl terephthalate and mixtures thereof.

In another embodiment the invention is a PVC composition comprising:
a) a PVC resin; and
b) a plasticizer composition, wherein said plasticizer composition is a blend comprising:
   i) at least one terephthalate diester of a C₃-C₅ linear or branched alcohol; and
   ii) an epoxidized oil.

In another embodiment the invention is a plasticizer composition comprising: a) a dibenzoate ester and b) an epoxidized oil.

In another embodiment the invention is a PVC composition comprising:
a) a PVC resin; and
b) a plasticizer composition, wherein said plasticizer composition is a blend comprising:
   i) at least one dibenzoate ester; and
   ii) an epoxidized oil.

In another embodiment the dibenzoate ester is selected from the group consisting of dipropylene glycol dibenzoates, diethylene glycol dibenzoates and triethylene glycol dibenzoates and mixtures thereof.

### DETAILED DESCRIPTION

### Definitions

In this specification and in the claims that follow, reference will be made to a number of terms, which shall be defined to have the following meanings.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a compound is described as containing components A, B, and/or C, the compound can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

As used herein the term “PVC” means poly vinyl chloride including polyvinyl chloride co vinyl acetate and polyvinyl chloride co vinyl acrylate.

In one embodiment, the present invention is a plasticizer

composition comprising a terephthalate diester where the alcohol group is a C₃-C₅ linear or branched composition blended with an epoxidized oil, where the weight ratio of terephthalate based material and the epoxidized oil is from 90:10 to 10:90. The weight ratio of the terephthalate based material and the epoxidized oil may be from 80:20 to 20:80. The preferred range, the weight ratio of the terephthalate based material and the epoxidized oil may be from 70:30 to 30:70. The most preferred range, the weight ratio of the terephthalate based material and the epoxidized oil may be from 60:40 to 40:60. The present invention also includes a PVC composition comprising 100 parts by weight of resin and 5-175 parts by weight of the plasticizer blend.

Suitable C₃-C₅ linear or branched terephthalate diesters for use in this invention include dibutyl terephthalate, isobutyl terephthalate, diisopentyl terephthalate, dipentyl terephthalate, dipropyl terephthalate, and diisopropyl terephthalate.

In another embodiment, the present invention is a plasticizer composition comprising a dibenzoate ester and an epoxidized oil. Suitable dibenzoate esters include dipropylene glycol dibenzoates, diethylene glycol dibenzoates and triethylene glycol dibenzoates and mixtures thereof. It is included within the scope of this invention that some monobenzoate esters may be included in dibenzoate compositions.

### EXAMPLES

This invention can be further illustrated by the following examples thereof, although it will be understood that these examples are included merely for purposes of illustration and are not intended to limit the scope of the invention unless otherwise specifically indicated.

### Example 1—Filled PVC Compositions

Formulations 1˜4 are shown in Table 1. Formulations 1 is the standard control formulation used in determining dry times where the total plasticizer concentration is 75 parts per hundred resin (phr). OxyVinyls® 240 available from Occidental Petroleum was used as the homopolymer PVC suspension resin. Burgess 30P® clay available from Burgess Pigment Company was added at 18 phr. Zn stearate and Ca stearate were used as heat stabilizers. Drapex® 6.8 from Galata Chemicals is an ESO used in these formulations. This oil can serve as both a heat stabilizer and as a plasticizer. The following plasticizers were used in Formulations 1-4; Dioctyl terephthalate (DOTP), ESO, DiBP and Dibutyl terephthalate (DBT).

TABLE 1
75 PHR Dry Blend Formulations used in determining dry time

| | Formulation | | | | | | | |
|---|---|---|---|---|---|---|---|---|
| | 1 | | 2 | | 3 | | 4 | |
| | g | phr | g | phr | g | phr | g | phr |
| OxyVinyls ® | 148.00 | 100.00 | 148.00 | 100.00 | 148.00 | 100.00 | 148.00 | 100.00 |
| 240 | | | | | | | | |
| Burgess 30P ® | 26.64 | 18.00 | 26.64 | 18.00 | 26.64 | 18.00 | 26.64 | 18.00 |
| Clay | | | | | | | | |
| Zn Stearate | 0.37 | 0.25 | 0.37 | 0.25 | 0.37 | 0.25 | 0.37 | 0.25 |
| Ca Stearate | 0.30 | 0.20 | 0.30 | 0.20 | 0.30 | 0.20 | 0.30 | 0.20 |
| ESO | 7.40 | 5.00 | 111.00 | 75.00 | 44.40 | 30.00 | 44.40 | 30.00 |
| DiBP | 0.00 | 0.00 | 0.00 | 0.00 | 66.60 | 45.00 | 0.00 | 0.00 |
| DBT | 0.00 | 0.00 | 0.00 | 0.00 | 0.00 | 0.00 | 66.60 | 45.00 |
| DOTP | 103.60 | 70.00 | 0.00 | 0.00 | 0.00 | 0.00 | 0.00 | 0.00 |

Formulations 5-7 are shown in Table 2. Formulations 5 through 7 were prepared as described above for Formulations 1 through 4.

TABLE 2
Dry Blend Formulations

| | Formulation | | | | | |
|---|---|---|---|---|---|---|
| | 5 | | 6 | | 7 | |
| | g | phr | g | phr | g | phr |
| OxyVinyls ® 240 | 148.00 | 100.00 | 148.00 | 100.00 | 148.00 | 100.00 |
| Burgess 30P ® Clay | 26.6 | 18.00 | 26.6 | 18.00 | 26.6 | 18.00 |
| Zn Stearate | 0.37 | 0.25 | 0.37 | 0.25 | 0.37 | 0.25 |
| Ca Stearate | 0.30 | 0.20 | 0.30 | 0.20 | 0.30 | 0.2 |
| ESO | 44.4 | 30.00 | 44.4.00 | 30.00 | 66.6 | 45.0 |
| DiBP | 0.00 | 0.00 | 0.00 | 0.00 | 0.00 | 0.00 |
| DBT | 66.6 | 45.00 | 0.00 | 0.00 | 44.0 | 30.0 |
| DPT* | 0.00 | 0.00 | 66.6 | 45.0 | 0.00 | 0.00 |

*Dipentyl terephthalate

### Example 2—Clear PVC Compositions

Formulations 8-17 are shown in Table 3. OxyVinyls® 240 was used as the homopolymer PVC suspension resin. Zn stearate and Ca Stearate were used as heat stabilizers. Drapex® 6.8 is an epoxidized soybean oil, this oil can serve as both a heat stabilizer and as a plasticizer. The solid and liquid components of the formulation, shown in Table 3, were weighed into a mixing container.

Each formulation was mixed until the plasticizer was absorbed into the resin and freely flowing. Temperature was monitored between mixing intervals and increased every cycle and typically finished around 190° F. The samples were then removed from the container and poured onto a piece of Kraft paper until the samples cooled to room temperature.

All formulations were evaluated for standard dry blend properties including exudation, and efficiency and film heat stability.

TABLE 3
Clear Dry Blend Formulations

| | Formulation | | | | | | | | | |
|---|---|---|---|---|---|---|---|---|---|---|
| | 8 | | 9 | | 10 | | 11 | | 12 | |
| | g | phr | g | phr | g | phr | g | phr | g | phr |
| Oxy 240 | 142.50 | 100.00 | 142.50 | 100.00 | 142.50 | 100.00 | 142.50 | 100.00 | 142.50 | 100.00 |
| Zn Stearate | 0.36 | 0.25 | 0.36 | 0.25 | 0.36 | 0.25 | 0.36 | 0.25 | 0.36 | 0.25 |
| Ca Stearate | 0.29 | 0.20 | 0.29 | 0.20 | 0.29 | 0.20 | 0.29 | 0.20 | 0.29 | 0.20 |
| ESO | 106.88 | 75.00 | 0.00 | 0.00 | 42.75 | 30.00 | 42.75 | 30.00 | 64.13 | 45.00 |
| DiBP | 0.00 | 0.00 | 0.00 | 0.00 | 64.13 | 45.00 | 0.00 | 0.00 | 0.00 | 0.00 |
| DBT | 0.00 | 0.00 | 0.00 | 0.00 | 0.00 | 0.00 | 64.13 | 45.00 | 42.75 | 30.00 |
| DOTP | 0.00 | 0.00 | 106.88 | 75.00 | 0.00 | 0.00 | 0.00 | 0.00 | 0.00 | 0.00 |
| VP-953 | 0.00 | 0.00 | 0.00 | 0.00 | 0.00 | 0.00 | 0.00 | 0.00 | 0.00 | 0.00 |
| | Formulation | | | | | | | | | |
| | 13 | | 14 | | 15 | | 16 | | 17 | |
| | g | phr | g | phr | g | phr | g | phr | g | phr |
| Oxy 240 | 142.50 | 100.00 | 166.20 | 100.00 | 166.20 | 100.00 | 124.70 | 100.00 | 124.70 | 100.00 |
| Zn Stearate | 0.36 | 0.25 | 0.42 | 0.25 | 0.42 | 0.25 | 0.31 | 0.25 | 0.31 | 0.25 |
| Ca Stearate | 0.29 | 0.20 | 0.33 | 0.20 | 0.33 | 0.20 | 0.25 | 0.20 | 0.25 | 0.20 |
| ESO | 42.75 | 30.00 | 83.10 | 50.00 | 33.24 | 20.00 | 124.70 | 100.00 | 49.88 | 40.00 |
| DiBP | 0.00 | 0.00 | 0.00 | 0.00 | 0.00 | 0.00 | 0.00 | 0.00 | 0.00 | 0.00 |
| DBT | 0.00 | 0.00 | 0.00 | 0.00 | 49.86 | 30.00 | 0.00 | 0.00 | 74.82 | 60.00 |
| DOTP | 0.00 | 0.00 | 0.00 | 0.00 | 0.00 | 0.00 | 0.00 | 0.00 | 0.00 | 0.00 |
| VP-953 | 64.13 | 45.00 | 0.00 | 0.00 | 0.00 | 0.00 | 0.00 | 0.00 | 0.00 | 0.00 |

### Dry Time Procedure (ASTM D2396):

A modified version of ASTM D2396 was used with a CW Brabender Intelli-Torque rheometer with 650 ml Sigma blade mixer. The mixer was heated isothermally at 190° F. with blades turning at 60 rpm. The empty mixer was calibrated then the premixed powders (computerized program will indicate when to add powders) were added. The mixing bowl was covered with the transparent acrylic cover during mixing. The acrylic cover was replaced with the prewetted dispersion funnel after approximately 4.5 minutes of mixing. After the PVC had mixed exactly 5 minutes, the plasticizer was added evenly into the plasticizer dispersion trough. The plasticizer was allowed to drain for 1 minute and then the funnel was replaced with the transparent acrylic cover. The dry time was visually observed (the point at which the mixture becomes dry is usually obvious). The visible dry time was correlated with a torque peak in the output. Dry time was calculated as the time in minutes between the addition of plasticizer (5.0 minutes) and the bottom of the peak at dry point.

### PVC Button Preparation for Hardness Measurement:

Twenty-five to fifty grams of each dry blend were made into buttons using a two-roll mill to mix and fuse the PVC and a Carver press was used to mold the PVC into a button. The temperature used on the two-roll mill was set between 160-180° C. (front) and 130-150 (back) depending on plasticizer loading. The dry blend was added and allowed to roll for 3 minutes. Once milled the hot PVC was placed into an aluminum button mold. The press was set at 185° C. and a 700-pound load was applied for 5 minutes, then a 30,000-pound load was applied for an additional 2 minutes then cooled. The plates were separated, and sample removed.

### PVC Film Preparation:

The dry blend formulations were made into films using a two-roll mill to mix and fuse each PVC formulation. A Carver press was used to mold the PVC into a 70-75 mil thick sheet. The temperature used on the two-roll mill was set at 175° C. (front) and 145° C. (back). The dry blend was added and allowed to roll for 3 minutes. Once milled the hot PVC was placed between two 10″×10″ metal plates with a 70-75 mil shim between them. The top plate had channels cut around the edges that allowed for excess PVC to flow out so that a consistently thick film could be obtained. The press was set at 174° C. and a 15,000-pound load was applied for 3 minutes, then a 30,000-pound load was applied for an additional 5 minutes before being cooled to 57° C. After being cooled the load was removed, the plates were separated, and sample removed.

### Shore A Hardness (ASTM D2240):

Each button was stored overnight in a controlled temperature and humidity (CTH) oven set at 25° C. and 50% RH prior to testing hardness. Hardness was measured on a Rex Durometer. The instrument was calibrated for the expected range of hardness using the appropriate calibration standard.

### Loop Spew (ASTM D3291):

Vinyl strips approximately 70 mil thick were cut from the sheets. Strip samples are allowed to equilibrate for 24 hours at room temperature before loop spew exudation testing. The films were die cut into 1.5-inch×0.5-inch sections and placed into loop spew testing jig. Four samples were removed from the jig at specified intervals, 4 hours, 1 day, and 7 days, and tested. Exudation is rated on a scale of 0-3 with higher value indicating greater exudation.

### VOC by EPA Method 24:

EPA method 24 is a gravimetric analysis where the sample is held at 110° C. for one hour.

### Film Weight Loss at Elevated Temperature:

Sheets were cut into 4″×1.5″ rectangles. Each sheet was weighed on an analytical balance prior to being placed in a CTH oven set at 50° C. and 50% humidity.

### Viscosity of Plasticizer or Plasticizer Blend (ASTM D445):

An SVM3000 Anton Paar rheometer was used to determine dynamic viscosity, density, and kinematic viscosity at 25° C. and 20° C. according to ASTM D445.

### Plasticizer Freezing Point:

The freezing point of neat or plasticizer blend was determined using a circulation bath capable of reaching −30° C. A 25 g sample was submerged into the bath and allowed to equilibrate at any given temperature for a minimum of 48 hours.

### Example 3—Plastisol Formulations

Nine plastisol formulations are listed in Table 4. Each formulation contained 50, 75 or 100 phr of plasticizer along with 3 phr Acrostab LT4798 as a heat stabilizer. The resin used in all formulations was Geon 121A. The target weight for each formulation was 200 g.

TABLE 4
Formulations 18-26

| | PZ Level | | | | | | | | |
|---|---|---|---|---|---|---|---|---|---|
| | 50 PHR | | 75 PHR | | 100 PHR | | 75 PHR | | 75 PHR |
| | Formulation | | | | | | | | |
| | 18 | | 19 | | 20 | | 21 | | 22 |
| | g | phr | g | phr | g | phr | g | phr | g |
| Geon 121A | 131.0 | 100 | 112.5 | 100 | 98.5 | 100 | 112.5 | 100 | 112.5 |
| Akrostab LT4798 | 3.93 | 3 | 3.38 | 3 | 2.96 | 3 | 3.38 | 3 | 3.38 |
| ESO | 65.5 | 50 | 84.4 | 75 | 98.5 | 100 | | | 33.8 |
| DiBP* | | | | | | | | | 50.6 |
| DBT* | | | | | | | | | |
| DOTP* | | | | | | | 84.4 | 75 | |
| Total | 200.4 | | 200.3 | | 200.0 | | 200.3 | | 200.3 |

| | PZ Level | | | | | | | | |
|---|---|---|---|---|---|---|---|---|---|
| | 75 PHR | 75 PHR | | 50 PHR | | 100 PHR | | 75 PHR | |
| | Formulation | | | | | | | | |
| | 22 | 23 | | 24 | | 25 | | 26 | |
| | phr | g | phr | g | phr | g | phr | g | phr |
| Geon 121A | 100 | 112.5 | 100 | 131.0 | 100 | 98.5 | 100 | 112.5 | 100 |
| Akrostab LT4798 | 3 | 3.38 | 3 | 3.93 | 3 | 2.96 | 3 | 3.38 | 3 |
| ESO | 30 | 33.8 | 30 | 26.2 | 20 | 39.4 | 40 | 50.6 | 45 |
| DiBP* | 45 | | | | | | | | |
| DBT* | | 50.6 | 45 | 39.3 | 30 | 59.1 | 60 | 33.8 | 30 |
| DOTP* | | | | | | | | | |
| Total | | 200.3 | | 200.4 | | 200.0 | | 200.3 | |

*diisobutylphthalate, dibutyl terephthalate, dioctyl terephthalate

Eight plastisol formulations are listed in Table 5. Many of these are repeats of the same formulations listed in Table 4 with the addition of Formulation 33 containing dipentyl terephthalate (DPT) and Formulation 34 containing a different blend ratio of DBT:ESO. Each formulation contained 50, 75 or 100 phr of plasticizer along with 3 phr Akrostab™ LT4798 available from Valtris Specialty Chemicals as a heat stabilizer. The PVC resin used in all formulations was Geon® 121A available from Mexichem Specialty Resins Inc. The target weight for each formulation was 320 g.

TABLE 5
Formulations 27-34.

| | PZ Level | | | | | | | |
|---|---|---|---|---|---|---|---|---|
| | 50 PHR | | 75 PHR | | 100 PHR | | 75 PHR | |
| | Formulation | | | | | | | |
| | 27 | | 28 | | 29 | | 30 | |
| | g | phr | g | phr | g | phr | g | phr |
| Geon 121A | 209.2 | 100 | 179.8 | 100 | 157.7 | 100 | 179.8 | 100 |
| Akrostab LT4798 | 6.28 | 3 | 5.39 | 3 | 4.73 | 3 | 5.39 | 3 |
| ESO | 104.6 | 50 | 134.9 | 75 | 157.7 | 100 | 53.9 | 30 |
| DPT* | | | | | | | | |
| DBT | | | | | | | 80.9 | 45 |
| Total | 320.1 | | 320.0 | | 320.1 | | 320.0 | |

| PZ Level | | | |
|---|---|---|---|
| 50 PHR | 100 PHR | 75 PHR | 75 PHR |
| Formulation | | | |
| 31 | 32 | 33 | 34 |

| | g | phr | g | phr | g | phr | g | phr |
|---|---|---|---|---|---|---|---|---|
| Geon 121A | 209.2 | 100 | 157.7 | 100 | 112.5 | 100 | 179.8 | 100 |
| Akrostab LT4798 | 6.28 | 3 | 4.73 | 3 | 3.38 | 3 | 5.39 | 3 |
| ESO | 41.8 | 20 | 63.1 | 40 | 33.8 | 30 | 67.4 | 37.5 |
| DPT* | | | | | 50.6 | 45 | | |
| DBT | 62.8 | 30 | 94.6 | 60 | | | 67.4 | 37.5 |
| Total | 320.1 | | 320.1 | | 200.3 | | 320.0 | |

*dipentyl terephthalate

Seven plastisol formulations are listed in Table 6. Three different epoxidized oils were studied, Drapex® 6.8, Vikoflex® ®7170 and Vikoflex® 7190 (both available from Arkema). Each formulation contained 75 phr of plasticizer along with 3 phr Akrostab™ LT4798 as a heat stabilizer. The dispersion resins for these formulations was Geon 121A. The target weight for each formulation was 200 g.

TABLE 6
Formulations 35-41 containing three different epoxidized oils

| | Formulation | | | | | | | | | | | | | |
|---|---|---|---|---|---|---|---|---|---|---|---|---|---|---|
| | 35 | | 36 | | 37 | | 38 | | 39 | | 40 | | 41 | |
| | g | phr | g | phr | g | phr | g | phr | g | phr | g | phr | g | phr |
| Geon 121A | 112.5 | 100 | 112.5 | 100 | 112.5 | 100 | 112.5 | 100 | 112.5 | 100 | 112.5 | 100 | 112.5 | 100 |
| Akrostab LT4798 | 3.38 | 3 | 3.38 | 3 | 3.38 | 3 | 3.38 | 3 | 3.38 | 3 | 3.38 | 3 | 3.38 | 3 |
| Drapex 6.8 | 84.4 | 75 | | | | | | | 33.8 | 30 | | | | |
| Vikoflex 7170 | | | 84.4 | 75 | | | | | | | 33.8 | 30 | | |
| Vikoflex 7190 | | | | | 84.4 | 75 | | | | | | | 33.8 | 30 |
| DBT | | | | | | | | | 50.6 | 45 | 50.6 | 45 | 50.6 | 45 |
| DOTP | | | | | | | 84.4 | 75 | | | | | | |
| Total | 200.3 | | 200.3 | | 200.3 | | 200.3 | | 200.3 | | 200.3 | | 200.3 | |

*Drapex ® 6.8 and Vikoflex ® 7170 are epoxidized soybean oil; Vikoflex ® 7190 is epoxidized linseed oil

Nine plastisol formulations are listed in Table 7. Vikoflex® 5075 is epoxidized propylene glycol dioleate having an oxirane content of 4.4%. This epoxidized oil was used at 50, 75, and 100 phr to compare to how it behaved compared to other epoxidized oils, Drapex® 6.8 (sold by Galata Chemicals), Vikoflex® 7170 and Vikoflex® 7190 (both sold by Arkema). A formulation containing Vikoflex® 5075 was compared to a formulation made with DOTP both at the same 75 phr level. 60/40 blends of DBT/Vikoflex® 5075 were also made at different phr levels.

TABLE 7
Formulations 42 through 50

| | PZ Level | | | | | | | | |
|---|---|---|---|---|---|---|---|---|---|
| | 50 PHR | | 75 PHR | | 100 PHR | | 75 PHR | | 75 PHR |
| | Formulation | | | | | | | | |
| | 42 | | 43 | | 44 | | 45 | | 46 |
| | g | phr | g | phr | g | phr | g | phr | g |
| Geon 121A | 131 | 100 | 112.5 | 100 | 98.5 | 100 | 112.5 | 100 | 112.5 |
| Akrostab LT4798 | 3.93 | 3 | 3.38 | 3 | 2.96 | 3 | 3.38 | 3 | 3.38 |
| Viko Flex 5075 | 65.5 | 50 | 84.4 | 75 | 98.5 | 100 | | | 0 |
| Drapex 6.8 | | | | | | | | | 84.4 |
| DBT | | | | | | | | | |
| DOTP | | | | | | | 84.4 | 75 | |
| Total | 200.4 | | 200.3 | | 200 | | 200.3 | | 200.3 |

| | PZ Level | | | | | | | | |
|---|---|---|---|---|---|---|---|---|---|
| | 75 PHR | 75 PHR | | 75 PHR | | 100 PHR | | 75 PHR | |
| | Formulation | | | | | | | | |
| | 46 | 47 | | 48 | | 49 | | 50 | |
| | phr | g | phr | g | phr | g | phr | g | phr |
| Geon 121A | 100 | 112.5 | 100 | 112.5 | 100 | 98.5 | 100 | 112.5 | 100 |
| Akrostab LT4798 | 3 | 3.38 | 3 | 3.38 | 3 | 2.96 | 3 | 3.38 | 3 |
| Viko Flex 5075 | 0 | 33.8 | 30 | 0 | 0 | 39.4 | 40 | 50.6 | 45 |
| Drapex 6.8 | 75 | | | 33.8 | 30 | | | | |
| DBT | | 50.6 | 45 | 50.6 | 45 | 59.1 | 60 | 33.8 | 30 |
| DOTP | | | | | | | | | |
| Total | | 200.3 | | 200.3 | | 200 | | 200.3 | |

### Plastisol Preparation

All liquids were weighed into a container. The PVC resin was then weighed into the container. Each container was placed into a mixer. The mixer was run at level 1 (1200 rpm for 20 s). The sample was then removed and stirred with a tongue depressor. The mixer was then run at level 4 (1600 rpm for 40 s). Temperature was not allowed to exceed 29° C. If the sample was completely mixed, no further mixing was conducted. If clumps of resin remained the sample was mixed at level 4 until a smooth fully mixed plastisol was obtained. All samples were de-aerated.

### Dynamic Viscosity Testing

Dynamic viscosity was measured on each plastisol after 1, and 7 days at room temperature using a rheometer. This technique uses a 25-40 mm parallel plate with a 0.5 mm gap configuration. The temperature was held at 25° C. while the shear rate was swept from 0.1 to 400 (1/s).

### Fusion Testing

All plastisols were run on a rheometer and both the gel point and fusion temperature were reported. This technique uses a 25 mm parallel plate with a 1.0 mm gap configuration, heating rate was 5° C./min from 40° C.-200° C., and the sample oscillation frequency was held at 1 Hz.

### PVC Film Preparation

PVC films (7.5″×5″) were prepared by pouring 110 grams of plastisol into a segmented aluminum mold that produce two 75 mil sheets. The mold was placed in a ventilated oven set at 190° C. and the mold was removed from the oven once the thermocouple inside the mold reached 170° C. The mold was cooled to room temperature in a hood, and the fused samples removed by pulling on the insert handle.

### PVC Button Preparation for Hardness Measurement

Twenty-five grams of each plastisol was poured into an aluminum button mold. The mold was placed in the Mathis oven at 190.6° C. for 30 minutes and each button was stored overnight in a CTH oven set at 25° C. and 50% RH prior to testing hardness.

### Film Property Measurements

The following properties were measured on the PVC films: Hardness (A), loop spew.

### Durometer A Hardness Measurements

Hardness A of each sample was measured according to ASTM D2240. Prior to testing the hardness of each film, 3 standard calibration buttons were measured to ensure the equipment was functioning properly. A ten second dwell time measurement was utilized for testing.

### Loop Spew Measurements

Vinyl strips approximately 75 mil thick were cut from the sheets. Strip samples are allowed to equilibrate for 24 hours at room temperature before loop spew exudation testing. The films were die cut into 1.5-inch×0.5-inch sections and placed into loop spew testing jig. Four samples were removed from the jig at specified intervals, 4 hours, 1 day, and 7 days, and tested. Loop Stress measurements were made on each flexible PVC formulation according to ASTM 3291.

### Results

Dry time—Table 8 lists the dry time results for Formulations 1-7. It can be seen that there are differences between the various plasticizers. The dry blend containing DOTP was used as a control. Formulation 2 containing 75 phr of ESO took 4.5 minutes to dry compared to 3.5 minutes for Formulation 1 made with the general-purpose plasticizer DOTP. The longer dry time for the ESO formulation will likely lead to longer processing times or require additional heat prior to adding it to the PVC resin. Blending in a lower molecular weight plasticizer having a lower viscosity such as DiBP or DBT at 60/40 ratio by weight with ESO leads to a dramatic reduction in dry times. When DiBP is blended with ESO a dry time of 2.2 minutes was achieved, when DBT is blended with ESO a dry time of 1.7 minutes was achieved. When non-phthalate plasticizers are required for producing a product, the addition of DBT to ESO will lower the processing time or eliminate the need to preheat the plasticizer. DBT provides non-phthalate options for providing similar or better properties compared to DiBP. Formulations 5-7 were made to see how dipentyl terephthalate (DPT) would perform compared to DBT. Also, to determine how the dry time would change when reducing the amount of DBT from 60% to 40% in a blend with ESO. When DPT is blended with ESO a dry time of 2.2 minutes was achieved, when DBT is blended with ESO a dry time of 1.7 minutes was achieved showing that DBT leads to faster dry times compared with DPT. When a 40/60 DBT/ESO blend was used, a dry time of 2.0 minutes was achieved showing that one can achieve faster dry times using less fast fuser when using DBT compared to both DiBP and DPT.

TABLE 8
Dry time; Hardness (A); Loop spew containing 75 phr plasticizer and 18 phr Clay

| | Formulation 1 | Fomulation 2 | Formulation 3 | Formulation 4 | Formulation 5 | Formulation 6 | Formulation 7 |
|---|---|---|---|---|---|---|---|
| Test | (DOTP) | (ESO) | (60/40 DiBP/ESO) | (60/40 DBT/ESO) | (60/40 DBT/ESO) | (60/40 DPT/ESO) | (40/60 DBT/ESO) |
| Hardness (A) | 76 | 74 | 73 | 71 | 69 | 71 | 71 |
| Dry Time (min) | 3.6 | 4.5 | 2.2 | 1.7 | 1.7 | 2.2 | 2.0 |
| 4 hr Loop Spew | 1.0 | 1.0 | 0.0 | 0.0 | 0.0 | 0.0 | 0.0 |
| 24 hr Loop Spew | 2.0 | 1.0 | 0.0 | 0.0 | 0.0 | 0.0 | 0.3 |
| 7 Day Loop Spew | 2.8 | 1.5 | 0.0 | 0.0 | 0.0 | 0.0 | 0.0 |

Efficiency—Table 8 lists the hardness results for Formulations 1-7. Hardness is a measure of the efficiency of the plasticizer, which is the plasticizer's ability to soften the flexible PVC, with lower hardness value equating to higher efficiency. The film made with ESO (Formulation 2) had a hardness of 74 A compared to a film made with DOTP (Formulation 1) which had a hardness of 76A. This would imply that the use of ESO has better efficiency compared to the DOTP control. Addition of a fast fusing plasticizer such as DBT (Formulation 4) or DiBP (Formulation 3) to ESO lowers the hardness of the film and hence improves the efficiency. Surprisingly in this study the film made in Formulation 4 containing the 60/40 DBT/ESO blend having a hardness of 71 A was found to be the most efficient. This finding shows that blends of DBT with ESO offer a significant improvement over pure ESO. Formulations 5-7 were also made to see how DPT would perform compared to DBT when reducing the amount of DBT from 60% to 40% in a blend with ESO. When DPT is blended with ESO a hardness of 71A was achieved, when DBT is blended with ESO a hardness of 69A was achieved showing that DBT is at least as efficient when compared with DPT. When DBT is blended with ESO at a ratio of 40/60 a hardness of 71A was achieved compared to 69A at a ratio of 60/40. This indicates that using a DBT/ESO blend containing between 40-60% DBT is a very effective plasticizer at lowering hardness.

Table 9 lists the hardness results for various formulations. The film made with ESO (Formulation 8) had a hardness of 68 A compared to a film made with DOTP (Formulation 9) which had a hardness of 72A. This would imply that ESO has better efficiency compared to the DOTP control. Addition of a fast fusing plasticizer such as DBT, DiBP, or Benzoflex™ VP-953 (a dibenzoate plasticizer available from Eastman Chemical Company) to ESO lowers the hardness of the film and hence improves the efficiency. Surprisingly the two films made containing the 60/40 DBT/ESO blend (Formulation 11 and a repeat sample) had hardness values of 62-63 and was found to be the most efficient blend tested when compared to DiBP (Formulation 10) and Benzoflex™ VP-953 (Formulation 13) at the same blend ratio. This finding shows that DBT blends with ESO provide improved plasticizing efficiency over pure ESO. Surprisingly Formulation 12 made with 40/60 DBT/ESO had a lower hardness of 64A when compared to Formulation 10 containing 60/40 DiBP/ESO indicating that when using DBT instead of DiBP more ESO can be incorporated into the formulation to obtain the same hardness film.

TABLE 9
Hardness (A); Loop spew of clear films containing 75 phr of plasticizer.

| | Formulation 8 | Formulation 9 | Formulation 10 | Formulation 11 | Formulation 11 | Formulation 12 | Formulation 13 |
|---|---|---|---|---|---|---|---|
| Test | (ESO) | (DOTP) | (60/40 DiBP/ESO) | (60/40 DBT/ESO) | (repeat) | (40/60 DBT/ESO) | (60/40 VP-953/ESO) |
| Hardness (A) | 68 | 72 | 65 | 63 | 62 | 64 | 67 |
| 4 hr Loop | 0 | 1 | 0 | 0 | 0 | 0 | 0 |
| Spew | | | | | | | |
| 24 hr Loop | 1 | 2 | 0 | 0 | 0 | 0 | 0 |
| Spew | | | | | | | |
| 7 Day Loop | 1 | 3 | 0 | 0 | 0 | 0 | 1 |
| Spew | | | | | | | |

Table 10 lists the hardness results for Formulations 8, 11, 14 and 15. The film made with ESO at 50 phr (Formulation 14) had a hardness of 87 A compared to a film made with the 60/40 DBT/ESO blend (Formulation 15) which had a hardness of 80A. The film made with ESO at 75 phr (Formulation 8) had a hardness of 68 A compared to a film made with the 60/40 DBT/ESO blend (Formulation 11) which had a hardness of 63A. At two different plasticizer loadings, this finding shows that DBT blends with ESO provide improved plasticizing efficiency over pure ESO.

TABLE 10
Efficiency as measured as durometer hardness (A) and loop spew
of clear films containing 50 and 75 phr of plasticizer.

| | | 75 phr | | 50 phr |
|---|---|---|---|---|
| | | 60/40 | | 60/40 |
| | 75 phr ESO | DBT/ESO | 50 phr ESO | DBT/ESO |
| | Formulation | Formulation | Formulation | Formulation |
| Test | 8 | 11 | 14 | 15 |
| Hardness (A) | 68 | 63 | 87 | 80 |
| 4 hr Loop | 0 | 0 | 0 | 0 |
| Spew | | | | |
| 24 hr Loop | 1 | 0 | 0 | 0 |
| Spew | | | | |
| 7 Day Loop | 1 | 0 | 0 | 0 |
| Spew | | | | |

Loop Spew—The formulations with filler, Formulations 1-7, have relatively few components so the exudation results indicate the plasticizers compatibility with the resin itself. Table 8 lists the loop spew results for the plasticizers tested. Films containing DOTP (Formulation 1) routinely gives loop spew values above 1 at all-time intervals. The film made with ESO (Formulation 2) shows better exudation performance than the standard general-purpose plasticizer, DOTP. At day 7 the film containing ESO had a loop spew value of 1.5 compared to 2.8 for the film made with DOTP. In many flexible PVC application areas however, any exudation may be an issue. This problem is solved by blending a more compatible plasticizer such as DBT or DiBP with ESO. Films made from formulations containing a 60/40 blend ratio of DBT/ESO (Formulation 4) or DiBP/ESO (Formulation 3) have no exudation. When non-phthalate plasticizers are required for producing a product, Table 8 shows the addition of DBT to ESO will eliminate ESO exudation from the film.

Dry blend formulations 5-7 listed in Table 8 were made and tested to determine how DPT would perform compared to DBT. Also, to determine how the loop spew would change when reducing the amount of DBT from 60% to 40% in a blend with ESO. DPT was found to be as effective as DBT at eliminating ESO exudation. DBT blended with ESO at a ratio of 40/60 is also found to be pretty effective at eliminating ESO exudation. Only a small hint of exudation was seen after 24 hours then no exudation was observed after 7 days.

The clear formulations, in Table 3, Formulations 8-17, have a minimal number of components, so the exudation results really indicate the plasticizers compatibility with the resin itself. Table 9 lists the loop spew results for the plasticizers tested at a loading of 75 phr. In this testing, the clear film made with ESO (Formulation 8) at 75 phr shows better exudation performance at the same plasticizer loading than the standard general-purpose plasticizer, DOTP (Formulation 9). At day 7 the film containing ESO had a loop spew value of 1.0 compared to 3.0 for the film made with DOTP. In many flexible PVC application areas however, any exudation may be an issue. This problem is solved by blending a more compatible plasticizer such as DBT or DiBP with ESO. Films made from formulations containing a 60/40 blend ratio of DBT/ESO (Formulation 11) or DiBP/ESO (Formulation 10) have no exudation. Even a film made from a formulation containing a 40/60 blend ratio of DBT/ESO (Formulation 12) had no exudation. When non-phthalate plasticizers are required for producing a product, the results in Table 9 indicate the addition of DBT to ESO will eliminate ESO exudation from the film when the amount of DBT in the blend falls between 40 and 60 weight percent. It should be noted that a film made from a formulation containing a 60/40 blend ratio of Benzoflex™ VP-953/ESO (Formulation 13) still show signs of exudation after 7 days.

Table 11 lists the loop spew results of films made with ESO at 50, 75, and 100 phr and a 60/40 DBT/ESO blend at 50, 75, and 100 phr. Films made with ESO are shown to exude as one increases the ESO loading in the film from 50 to 100 phr. At 50 phr (Formulation 14) no exudation occurs however, films made with ESO at 75 phr (Formulation 8) have an exudation rating of 1 after 24 hr. and 7 days. At 100 phr of ESO (Formulation 16) the amount of exudation increases even more, having an exudation rating of 1.3 after just 4 hours and a rating of 1.5 after both 24 hours and 7 days. This problem is solved by blending a more compatible plasticizer such as DBT with ESO. Films made from formulations containing 50, 75, and even 100 phr of a 60/40 blend ratio of DBT/ESO (Formulation 15, 11, 17) have no exudation. Table 11 clearly shows the addition of DBT to ESO will eliminate ESO exudation from the film even at plasticizer loadings as high as 100 phr.

TABLE 11
Loop Spew results in clear formulations containing 50, 75, or 100 phr of plasticizer; ESO or a 60/40 DBT/ESO blend

| | ESO | DBT/ESO blend | ESO | DBT/ESO blend | ESO | DBT/ESO blend |
|---|---|---|---|---|---|---|
| | at 75 phr | at 75 phr | at 50 phr | at 50 phr | at 100 phr | at 100 phr |
| Test | Formulation 8 | Formulation 11 | Formulation 14 | Formulation 15 | Formulation 16 | Formulation 17 |
| 4 hr Loop Spew | 0.0 | 0.0 | 0.0 | 0.0 | 1.3 | 0.0 |
| 24 hr Loop Spew | 1.0 | 0.0 | 0.0 | 0.0 | 1.5 | 0.0 |
| 7 Day Loop Spew | 1.0 | 0.0 | 0.0 | 0.0 | 1.5 | 0.0 |

Neat Plasticizer Volatility—The volatility of the plasticizer compositions evaluated in this study are listed in Table 12. Dibutyl phthalate tested has about 1.7 times lower volatility compared to DiBP. The terephthalate version, DBT tested has approximately 18% lower volatility compared to its orthophthalate counterpart, DBP. The use of DBT over the two orthophthalate molecules will lead to lower volatility during processing and make the flexible films more resistant to weight loss at elevated temperatures. DPT having a higher molecular weight than DBT has approximately 53% lower volatility compared to DBT. ESO has a molecular weight of around 1000 daltons and hence has little volatility. Blending ESO with molecules such as DBT, DBP and DiBP will lower the overall volatility of the plasticizer as shown in Table 12. A 60/40 blend of DiBP/ESO has a weight loss of 12.5 weight % compared to 15.4 weight % for DiBP. A 60/40 blend of DBT/ESO has a weight loss of 4.0 weight % compared to 7.3 weight % for DBT. A 40/60 blend of DBT/ESO has a weight loss of 2.6 weight % compared to 7.3 weight % for DBT. These examples show that by blending ESO with DBT the volatility for a given blend decreases.

TABLE 12
EPA Method 24 Volatility

| Neat Plasticizer | VOC (weight %) |
|---|---|
| DiBP | 15.35 |
| DBP | 8.89 |
| Benzoflex ™ VP-953 | 2.43 |
| DBT | 7.31 |
| DPT | 3.46 |
| DOTP | 0.24 |
| ESO | 0.17 |
| 60/40 DiBP/ESO | 12.54 |
| 60/40 DBT/ESO | 3.99 |
| 40/60 DBT/ESO | 2.55 |

Film weight loss at elevated temperature—The ability of a PVC film to maintain its physical properties over time is important. Heat can affect the PVC films ability to maintain its physical properties. Plasticizer can volatilize out of films at elevated temperatures. Table 13 shows the weight loss of a films containing 75 phr of plasticizer aged in a CTH oven at 50° C. for 10 days and 30 days. Clear films containing DOTP or ESO actually gained a small amount of weight in this test. The clear film containing a 60/40 blend of DiBP/ESO lost the most weight losing 3.4 weight % after 10 days and 8.2 weight % after 30 days. Two clear films were made containing a 60/40 blend of DBT/ESO to see how reproducible the results were. These two films containing a 60/40 blend of DBT/ESO lost approximately four times less weight than a comparison sample made with a 60/40 blend of DiBP/ESO. The samples lost 0.6-0.8 weight % after 10 days and 1.9-2.1 weight % after 30 days. The clear film containing a 40/60 blend of DBT/ESO lost loss less than the 60/40 DBT/ESO weight loss showing a balance of performance and weight loss can be optimized for a given application. The 40/60 blend of DBT/ESO sample lost 0.2 weight % after 10 days and 0.6 weight % after 30 days. The clear sample made with Benzoflex™ VP-953 at a blend ratio of 60/40 VP-953/ESO had the lowest weight loss when compared to DBT and DiBP at the same ratio.

TABLE 13
PVC Film weight loss aged in a CTH oven at 50°
C. and 50% humidity vs time (Filled and clear
formulations containing 75 phr of plasticizer)

| | Formulation | | | |
|---|---|---|---|---|
| | contains | | Weight % | Weight % |
| | filler or is | Plasticizer used | loss | loss |
| Formulation | clear | (75 phr) | (10 days) | (30 days) |
| 1 | Filler | DOTP | −0.5 | −1.4 |
| 2 | Filler | ESO | −0.3 | −0.8 |
| 3 | Filler | 60/40 | 3.2 | 8.1 |
| | | DIBP/ESO | | |
| 4 | Filler | 60/40 DBT/ESO | 1.1 | 3.2 |
| 8 | Clear | ESO | −0.7 | −1.7 |
| 9 | Clear | DOTP | −0.4 | −1.0 |
| 10 | Clear | 60/40 | 3.4 | 8.2 |
| | | DIBP/ESO | | |
| 11 | Clear | 60/40 DBT/ESO | 0.8 | 2.1 |
| 11 (repeat) | Clear | 60/40 DBT/ESO | 0.6 | 1.9 |
| 12 | Clear | 40/60 DBT/ESO | 0.2 | 0.6 |
| 13 | Clear | 60/40 VP- | 0.2 | 0.3 |
| | | 953/ESO | | |
| 5 | Filler | 60/40 DBT/ESO | 0.6 | 1.7 |
| 6 | Filler | 60/40 DPT/ESO | −0.2 | −0.3 |
| 7 | Filler | 40/60 DBT/ESO | 0.3 | 1.0 |

Table 13 also shows the weight loss of films made with filler from Table 1 containing 75 phr of plasticizer aged in a CTH oven at 50° C. for 10 days and 30 days. The negative weight loss values for films containing DOTP or ESO are indicative of a small increase in weight in this test. The film containing a 60/40 blend of DiBP/ESO lost the most weight losing 3.2 weight % after 10 days and 8.1 weight % after 30 days. The film containing a 60/40 blend of DBT/ESO lost approximately 2.5-3 times less weight than a comparison sample made with a 60/40 blend of DiBP/ESO. The samples lost 1.1 weight % after 10 days and 3.2 weight % after 30 days. The three filled dry blend formulations listed in Table 2 were made to see how DPT would perform compared to DBT. Also, to determine how the weight loss would change when reducing the amount of DBT from 60% to 40% in a blend with ESO. The weight loss at 50° C. results after 10 days, 30 days. The results show that at 50° C. films made with DPT at equivalent amounts compared to DBT lost much less weight. After 30 days the film containing DPT gained −0.3 weight % vs 1.7 weight % loss for the film containing DBT. As expected reducing the amount of DBT from 60:40 DBT:ESO to 40:60 DBT:ESO in films led to less weight loss.

### Plastisol Formulations

In this work we compared typical plastisol/film properties obtained when using epoxidized oils or blends of epoxidized oils with various fast fusers to the most widely used non-phthalate general purpose plasticizer DOTP.

### Plastisol/Film Properties of Formulations 18-26 in Table 4

The epoxidized oil used in this set of formulations was Drapex® 6.8. Drapex® 6.8 is an epoxidized soybean oil (ESO) having an oxirane oxygen content of 7%. In this series we made plastisols containing 50, 75 and 100 phr of ESO and compared the properties to plastisols made containing 50, 75 and 100 phr of a 60:40 weight % blend of DBT:ESO. We also made plastisols containing 75 phr of DOTP, a 60:40 blend of DiBP:ESO, and a 40:60 blend of DBT:ESO.

### Dynamic Viscosity

Dynamic viscosity results measured after 24 hours at 1/s, 10/s and 100/s are listed in Table 14. When comparing viscosities at 10/s of all plastisol formulations made with 75 phr of plasticizer, ESO has a significantly higher viscosity (6,399 cP) when compared to DOTP (1,230 cP). The viscosity can be reduced by blending a fast fuser such as DiBP or DBP with ESO. When comparing viscosities at 10/s of the plastisol formulations made with 75 phr of fast fuser:ESO blends to DOTP one can achieve comparable viscosities. The 60:40 DiBP:ESO has a viscosity (2,400 cP), the 60:40 DBT:ESO has a viscosity (1,608 cP), when compared to DOTP (1,230 cP). The 60:40 DBT:ESO has a lower viscosity than the same formulation where DiBP is used indicating that DBT is more effective at reducing the plastisol viscosity than DiBP. In fact, a 40:60 DBT:ESO has a viscosity (2,251 cP) compared to 60:40 DiBP:ESO (2,400 cP), indicating more ESO can be incorporated to obtain the same viscosity.

TABLE 14
Dynamic viscosity, gel point and fusion temperatures, durometer
hardness (A), exudation results of Formulations 18-26

| | | | | | 24 hr | 24 hr | 24 hr |
|---|---|---|---|---|---|---|---|
| | | 24 hr | Gel | Fusion | Viscosity | Viscosity | Viscosity |
| | | Hardness | Point | Point | @ 1/s | @ 10/s | @ 100/s |
| Formulation | PZ | (A) | (° C.) | (° C.) | (cps) | (cps) | (cps) |
| 18 | ESO 50 phr | 81 | 70.1 | 130.3 | 26,117 | 405,055 | 208,817 |
| 19 | ESO 75 phr | 65 | 78.4 | 135.5 | 5,528 | 6,399 | 12,323 |
| 20 | ESO 100 phr | 53 | 89.5 | 135.8 | 3,338 | 3,367 | 4,119 |
| 21 | DOTP 75 phr | 67 | 81.3 | 133.8 | 1,429 | 1,230 | 3,121 |
| 22 | DiBP:ESO | 60 | 66.9 | 108.6 | 2,375 | 2,400 | 3,342 |
| | (60:40) | | | | | | |
| | 75 phr | | | | | | |
| 23 | DBT:ESO | 73 | 56.2 | 79.8 | 10,754 | 8,810 | 102,748 |
| | (60:40) | | | | | | |
| | 50 phr | | | | | | |
| 24 | DBT:ESO | 60 | 64.5 | 112.3 | 1,819 | 1,608 | 2,091 |
| | (60:40) | | | | | | |
| | 75 phr | | | | | | |
| 25 | DBT:ESO | 50 | 69.2 | 112.8 | 915 | 787 | 874 |
| | (60:40) | | | | | | |
| | 100 phr | | | | | | |
| 26 | DBT:ESO | 62 | 68.6 | 121.2 | 2,441 | 2,251 | 3,460 |
| | (40:60) | | | | | | |
| | 75 phr | | | | | | |

| | 7 day | 7 day | 7 day | | | |
|---|---|---|---|---|---|---|
| | Viscosity | Viscosity | Viscosity | | | |
| | @ 1/s | @ 10/s | @ 100/s | 4 hr | 24 hr | 7 Day |
| Formulation | (cps) | (cps) | (cps) | Exudation | Exudation | Exudation |
| 18 | 32,502 | 482,320 | 211,957 | 0.0 | 1.0 | 1.8 |
| 19 | 6,446 | 7,379 | 13,126 | 1.0 | 1.0 | 1.8 |
| 20 | 3,304 | 3,683 | 4,864 | 1.0 | 1.0 | 1.5 |
| 21 | 1,640 | 1,521 | 3,227 | 2.0 | 2.5 | 3.0 |
| 22 | 3,899 | 3,515 | 4,529 | 0.0 | 0.0 | 0.0 |
| 23 | 18,087 | 14,764 | 136,908 | 0.0 | 0.0 | 0.0 |
| 24 | 2,412 | 2,109 | 2,791 | 0.0 | 0.0 | 0.0 |
| 25 | 1,105 | 965 | 1,076 | 0.0 | 0.0 | 0.0 |
| 26 | 2,960 | 2,821 | 4,149 | 0.3 | 1.0 | 0.0 |

Dynamic viscosity results measured after 7 days at 1/s, 10/s and 100/s are listed in Table 14. The seven day viscosity values have not changed much compared to the 24 hour values indicating the plastisol formulations containing ESO are pretty stable.

### Gel Point and Fusion Peak Temperature

Table 14 includes the gel point and fusion temperature results of plastisols listed in Table 4. When comparing the gel point and fusion temperature of all plastisol formulations made with 75 phr of plasticizer, ESO has a similar gel point and fusion temperature when compared to DOTP. The gel point and fusion temperature can be reduced by blending a fast fuser such as DiBP or DBP with ESO. When comparing gel point and fusion temperature of the plastisol formulations made with 75 phr of fast fuser:ESO blends to DOTP the gel point and fusion temperature are in fact reduced by 15-20° C. Reducing the amount of DBT from 60:40 DBT:ESO to 40:60 DBT:ESO still leads to a lower gel point and fusion temperature when compared to either DOTP or ESO alone.

### Durometer A Hardness

Table 14 includes the hardness results for buttons made from the clear formulations listed in Table 4 using 75 phr of plasticizer. The film made with ESO had a hardness of 65 A compared to a film made with DOTP which had a hardness of 67 A. This would imply that the use of ESO has better efficiency compared to the DOTP control. Addition of a fast fusing plasticizer such as DBT, DiBP to ESO lowers the hardness of the film and hence improves the efficiency. In this work, films containing either 60:40 DBT:ESO blend or a 60:40 DiBP:ESO had hardness's of 60 A. A film containing a 40:60 DBT:ESO blend had a hardness of 62 A. This finding shows that DBT when blended with ESO, is a plasticizer capable of improving the plasticizing efficiency of ESO.

Table 14 also lists the hardness results for buttons made from the clear formulations listed in Table 4 using ESO and a 60:40 DBT:ESO blend at a plasticizer loading level of 50, 75 and 100 phr. At each plasticizer loading level the 60:40 DBT:ESO blend has hardness values significantly lower than ESO. This finding shows that DBT when blended with ESO, is a plasticizer capable of improving the plasticizing efficiency of ESO.

### Loop Spew

An important performance attribute of any plasticizer is its ability to stay in the PVC matrix. Incompatibility with any of the components of a formulation can cause the plasticizer to migrate to the surface of the PVC part, also known as exudation. Loop spew values for PVC samples made from plastisols in Table 4 at a plasticizer loading level of 75 phr are listed in Table 14. The clear formulations listed in Table 4 tested here have a minimal number of components, so the exudation results really indicate the plasticizers compatibility with the resin itself. In this testing, the clear film made with ESO at 75 phr shows better exudation performance at the same plasticizer loading than the standard general-purpose plasticizer, DOTP. At day 7 the film containing ESO had a loop spew value of 1.8 compared to 3.0 for the film made with DOTP. In many flexible PVC application areas however, any exudation may be an issue. We have solved this exudation issue by blending a more compatible plasticizer such as DBT or DiBP with ESO. Films made from formulations containing a 60:40 blend ratio of DBT:ESO or DiBP:ESO have no exudation. Even a film made from a formulation containing a 40:60 blend ratio of DBT:ESO had a low amount of exudation. When non-phthalate plasticizers are required for producing a product, the results listed in Table 14 indicates the addition of DBT to ESO will eliminate ESO exudation from the film when the DBT:ESO ratio is 60:40.

In Table 14, films made with ESO are all shown to exude at ESO loadings ranging from 50 to 100 phr. We have solved this exudation issue by blending a more compatible plasticizer such as DBT with ESO. In this example, films made from formulations containing 50, 75, and even 100 phr of a 60:40 blend ratio of DBT:ESO have no exudation. The addition of DBT to ESO at a ratio of 60:40 will eliminate ESO exudation from the film even at plasticizer loadings as high as 100 phr.

### Plastisol/Film Properties of Formulations 27-34 in Table 5

The formulations in Table 5 were made to understand the repeatability of the all ESO and 60:40 DBT:ESO blends at a plasticizer loading level of 50, 75 and 100 phr. In addition, dipentyl terephthalate (DPT) was incorporated in a 60:40 DPT:ESO blend to see how DPT would perform as a fast fuser in place of DBT. Also, a 50:50 DBT:ESO blend was made to see how it compares to the 60:40 blend.

### Dynamic Viscosity

Some of the formulations made in Table 4 were made a second time and are included in Table 5. Results listed in Table 15 indicate the plastisols that were made up a second time show good repeatability in terms of the dynamic viscosity at a shear rate of 1/s, 10/s and 100/s after 24 hours.

TABLE 15
Dynamic viscosity, gel point and fusion temperatures, durometer hardness
(A), exudation results of Formulations 18-20, 23-25, and 27-34

| | | | | | 24 hr | 24 hr | 24 hr |
|---|---|---|---|---|---|---|---|
| | | 24 hr | Gel | Fusion | Viscosity | Viscosity | Viscosity |
| | | Hardness | Point | Point | @ 1/s | @ 10/s | @ 100/s |
| Formulation | PZ | (A) | (° C.) | (° C.) | (cps) | (cps) | (cps) |
| 18 | ESO (50) | 80.8 | 70.1 | 130.3 | 26,117 | 405,055 | 208,817 |
| 27 | ESO (50)R | 81.5 | 69.7 | 131.5 | 24,288 | 381,552 | 191,691 |
| 19 | ESO (75) | 65.1 | 78.4 | 135.5 | 5,528 | 6,399 | 12,323 |
| 28 | ESO (75)R | 65.1 | 78.4 | 135.8 | 5,661 | 5,875 | 11,068 |
| 20 | ESO (100) | 53.4 | 89.5 | 135.8 | 3,338 | 3,367 | 4,119 |
| 29 | ESO (100)R | 52.7 | 89.0 | 136.2 | 2,916 | 2,881 | 3,897 |
| 23 | DBT:ESO | 60.0 | 64.5 | 112.3 | 1,819 | 1,608 | 2,091 |
| | (60:40) (75) | | | | | | |
| 30 | DBT:ESO | 61.0 | 64.6 | 112.1 | 1,831 | 1,625 | 2,023 |
| | (60:40) (75)R | | | | | | |
| 24 | DBT:ESO | 73.3 | 56.2 | 79.8 | 10,754 | 8,810 | 102,748 |
| | (60:40) (50) | | | | | | |
| 31 | DBT:ESO | 74.2 | 55.8 | 79.4 | 11,177 | 8,473 | 120,070 |
| | (60:40) (50)R | | | | | | |
| 25 | DBT:ESO | 50.1 | 69.2 | 112.8 | 915 | 787 | 874 |
| | (60:40) (100) | | | | | | |
| 32 | DBT:ESO | 50.1 | 69.1 | 114.1 | 798 | 742 | 781 |
| | (60:40) (100)R | | | | | | |
| 33 | DPT:ESO | 61.5 | 69.2 | 118.7 | 2,159 | 1,824 | 2,090 |
| | (60:40)(75) | | | | | | |
| 34 | DBT:ESO | 59.6 | 66.8 | 116.0 | 2,132 | 1,936 | 2,586 |
| | (50:50)(75) | | | | | | |

| | 7 day | 7 day | 7 day | | | |
|---|---|---|---|---|---|---|
| | Viscosity | Viscosity | Viscosity | | | |
| | @ 1/s | @ 10/s | @ 100/s | 4 hr | 24 hr | 7 Day |
| Formulation | (cps) | (cps) | (cps) | Exudation | Exudation | Exudation |
| 18 | 32,502 | 482,320 | 211,957 | 0.0 | 1.0 | 1.8 |
| 27 | 27,672 | 299,301 | 204,585 | 0.0 | 0.5 | 1.8 |
| 19 | 6,446 | 7,379 | 13,126 | 1.0 | 1.0 | 1.8 |
| 28 | 6,342 | 6,409 | 11,441 | 1.0 | 1.0 | 1.5 |
| 20 | 3,304 | 3,683 | 4,864 | 1.0 | 1.0 | 1.5 |
| 29 | 3,040 | 2,953 | 3,903 | 1.3 | 1.3 | 1.3 |
| 23 | 2,412 | 2,109 | 2,791 | 0.0 | 0.0 | 0.0 |
| 30 | 2,051 | 1,803 | 2,279 | 1.0 | 0.0 | 0.0 |
| 24 | 18,087 | 14,764 | 136,908 | 0.0 | 0.0 | 0.0 |
| 31 | 15,490 | 11,067 | 86,909 | 0.0 | 0.0 | 0.0 |
| 25 | 1,105 | 965 | 1,076 | 0.0 | 0.0 | 0.0 |
| 32 | 877 | 823 | 884 | 0.0 | 0.0 | 0.0 |
| 33 | 2,251 | 1,908 | 2,514 | 1.0 | 1.0 | 0.3 |
| 34 | 2,308 | 2,098 | 2,857 | 0.0 | 0.0 | 0.0 |

The 24 hour dynamic viscosity of Formulation 33 made with 75 phr of a 60:40 DPT:ESO blend is compared to Formulation 30 made with 75 phr of a 60:40 DBT:ESO blend in Table 15. The plastisol made with the DPT:ESO blend has a slightly higher viscosity than the plastisol made with DBT:ESO at the same ratio. A plastisol made with 75 phr of a 50:50 DBT:ESO is slightly more viscous than both the DPT:ESO and DBT:ESO at a blend ratio of 60:40.

The 7 day dynamic viscosity results are listed in Table 15. The same viscosity trends for these three plastisols observed after 24 hours were observed again after 7 days. All three plastisols showed similar viscosity age stability with each having a slightly higher viscosity than what was measured after 24 hours.

### Gel Point and Fusion Peak Temperature

Some of the formulations made in Table 4 were made a second time and are included in Table 5. The gel point and fusion temperature results listed in Table 15 indicates the plastisols that were made a second time show good repeatability.

From Table 15 one can compare the gel point and fusion temperatures obtained on plastisols containing 75 phr of a 60:40 DBT:ESO blend vs a 60:40 DPT:ESO blend. Both the gel point and fusion temperature of 69° C. and 119° C. is slightly higher for the DPT:ESO blend than the gel point and fusion temperature of 65° C. and 112° C. for the DBT:ESO blend. Changing the ratio of DBT:ESO from 60:40 to 50:50 was found to increase the gel point by just a few degrees and the fusion temperature by about 4 degrees. Based on these findings DBT can reduce the gel and fusion properties of a plastisol better than DPT. In fact, a 50:50 DBT:ESO blend leads to a slightly lower gel point and fusion temperature than a 60:40 DPT:ESO blend indicating that less DBT can be added when compared to DPT to accomplish the desired gel point and fusion temperature.

### Durometer A Hardness

The hardness results listed in Table 15 indicate the plastisols that were made a second time show good repeatability in terms of the hardness measurements obtained.

From Table 15 the results indicate the hardness values obtained on films containing 75 phr of a 60:40 DBT:ESO blend vs a 60:40 DPT:ESO blend are virtually identical within the accuracy of the measurement. Changing the ratio of DBT:ESO from 60:40 to 50:50 was not enough to affect the hardness within the accuracy of the measurement.

### Loop Spew

The exudation results listed in Table 15 indicates the plastisols containing ESO or a 60:40 DBT:ESO blend at a plasticizer level of 50, 75, or 100 phr that were made up second time show good repeatability in terms of the loop spew measurements obtained.

Table 15 lists the loop spew results obtained on films containing 75 phr of a 60:40 DBT:ESO blend vs a 60:40 DPT:ESO blend. Films containing the DPT:ESO blend spew more plasticizer from the film than the DBT:ESO

### Plastisol/Film Properties of Formulations 35-41 in Table 6

The formulations in Table 6 containing 75 phr of plasticizer were made to determine if there are any differences in the three epoxidized vegetable oils and how they compare to DOTP. In all the previous work conducted, Drapex® 6.8 from Galata having a typical % oxirane of 7% was utilized. Both Drapex® 6.8 and Vikoflex® 7170 sold by Arkema are epoxidized soybean oil (ESO). Vikoflex® 7170 is listed as having a minimum % oxirane of 6.8. These two ESO samples should perform the same and we tested to verify this. The additional product tested was Vikoflex® 7190 sold by Arkema. Vikoflex® 7190 is an epoxidized linseed oil (ELSO) having a listed minimum % oxirane of 9.0. It has a viscosity at 25° C. of 650 cP compared to Drapex® 6.8 having a viscosity at 25° C. of 320 cP. We will see how these differences in neat plasticizer viscosity will affect the plastisol viscosity.

### Dynamic Viscosity

The 24 hour and 7 day dynamic viscosity at a shear rate of 10/s of plastisols containing 75 phr of three epoxidized oils are listed in Table 16. The viscosity of a plastisol made with ELSO is about two times more viscous than the two plastisols made with ESO. This plastisol viscosity increase correlates well with the fact that the neat plasticizer viscosity is two times higher. While not wishing to be bound by a particular theory, this may be due to the increase in the % oxirane content present in the ELSO.

TABLE 16
Dynamic viscosity, gel point and fusion temperatures, durometer
hardness (A), exudation results of Formulations 35-41

| | | | | | 24 hr | 7 day | | | |
|---|---|---|---|---|---|---|---|---|---|
| | | | Gel | Fusion | Viscosity | Viscosity | | | |
| | | Hardness | Point | Point | @ 10/s | @ 10/s | 4 hr | 24 hr | 7 day |
| Formulation | PZ's | (A) | (° C.) | (° C.) | (cps) | (cps) | Exudation | Exudation | Exudation |
| 35 | Drapex 6.8 | 65 | 77.2 | 133.9 | 7989 | 9042 | 1.0 | 1.0 | 2.0 |
| 36 | Vikoflex 7170 | 65 | 77.2 | 134.2 | 11412 | 11796 | 1.0 | 1.0 | 1.3 |
| 37 | Vikoflex 7190 | 64 | 74.7 | 121.0 | 26845 | 31245 | 0.0 | 0.0 | 1.0 |
| 38 | DOTP | 67 | 78.2 | 134.5 | 1286 | 1355 | 2.0 | 3.0 | 3.0 |
| 39 | DBT:Drapex | 61 | 64.5 | 112.7 | 1828 | 2036 | 0.0 | 0.0 | 0.0 |
| | 6.8 | | | | | | | | |
| 40 | DBT:Vikoflex | 61 | 63.9 | 112.6 | 2064 | 2343 | 0.0 | 0.0 | 0.0 |
| | 7170 | | | | | | | | |
| 41 | DBT:Vikoflex | 61 | 62.9 | 104.7 | 2827 | 2976 | 0.0 | 0.0 | 0.0 |
| | 7190 | | | | | | | | |

The blending of DBT into these epoxidized oils at a 60:40 ratio was found to lead to a large reduction in viscosity.

The 24 hour and 7 day dynamic viscosity results of plastisols containing 75 phr of DOTP or a 60:40 DBT/Epoxidized oil blend are also listed in Table 16. The viscosity of the three blends are pretty stable with time, with only a slight increase in viscosity observed between 24 hours and 7 days. As expected, the plastisol made with DBT:ELSO blend is more viscous than the two plastisols made with a DBT:ESO blend. When comparing the dynamic viscosity of the DOTP plastisol to a plastisol based on the 60:40 DBT/ESO blends, one finds the blends are in the same viscosity range

### Gel Point and Fusion Peak Temperature

The gel point and fusion peak temperature results are listed in Table 16. These results come from plastisols containing 75 phr of DOTP, the three epoxidized oils, or the 60:40 DBT/Epoxidized oil blends listed in Table 6. The two ESO based plastisols each have a % oxirane content close to 7 and thus should have very similar properties. Plastisols made from both ESO suppliers lead to plastisols having the same gel point and fusion temperature. These ESO based plastisols have almost the exact gel point and fusion temperature as the DOTP based plastisol. The plastisol sample containing neat ELSO has a lower gel point and even lower fusion temperature than the plastisols containing ESO. This indicates that ELSO having a minimum % oxirane content of 9 is more effective at reducing gel and fusion compared to ESO. Addition of a DBT as a fast fuser at 60 weight % to the epoxidized oils, lowers the gel point by about 12° C. and fusion temperature by about 20° C. The DBT:ELSO blend, as expected for reason discussed above, also has a lower fusion temperature compared to the DBT:ESO blend.

### Durometer A Hardness

Durometer hardness (A) results are listed in Table 16. These results come from fused buttons made from plastisols containing 75 phr of DOTP, the three epoxidized oils, or the 60:40 DBT/Epoxidized oil blends listed in Table 6. Plastisols made from both ESO suppliers as expected lead to buttons having the same hardness. These neat ESO based plastisols have hardness values slightly lower than the DOTP based sample, indicating that ESO is the same or slightly more efficient than DOTP in lowering sample hardness. The sample containing neat ELSO has a hardness similar to samples containing ESO indicating they have similar efficiencies. Addition of a DBT as a fast fuser at 60 weight % to the epoxidized oils lowers the hardness value by almost 4A units.

### Loop Spew

Loop spew testing results are listed in Table 16. These results come from films made from plastisols containing 75 phr of plasticizer listed in Table 6. The plastisols made from both ESO suppliers, as expected, lead to films having the same amount of exudation. Like we have observed with neat ESO based films described earlier, the exudation values are lower than the DOTP based sample. The sample containing neat ELSO appears to exude less than the neat ESO based samples, indicating a higher % oxirane content leads to better compatibility. Even with ELSO being slightly more compatible, exudation was still observed on day 7. Addition of a DBT as a fast fuser at 60 weight % to all the epoxidized oils was found to eliminate exudation.

### Plastisol/Film Properties of Formulations 42-50 in Table 7

The formulations in Table 7 were made to determine if there are any differences in the epoxidized vegetable oils and how they compare to DOTP. Vikoflex® 5075 having an oxirane content of 4.4% was formulated at 50, 75, and 100 phr. In previous example Drapex® 6.8, Vikoflex® 7170, and Vikoflex® 7190 were formulated at 50, 75, and 100 phr and their properties compared to each other.

### Dynamic Viscosity

The 24 hour and 7 day dynamic viscosity of plastisols are listed in Table 17. Both the 24 hour and 7 day viscosity of the Vikoflex® 5075 formulation containing 75 phr has a significantly lower viscosity than a formulation containing 75 phr of Drapex® 6.8. It can be seen by these results that an epoxidized oil such as Vikoflex® 5075 is very effective at lowering the viscosity of plastisols. When formulating DBT in combination with Vikoflex® 5075 an even lower viscosity can be obtained.

TABLE 17
Dynamic viscosity, gel point and fusion temperatures, durometer hardness (A), exudation results of Formulations 42-50

| | | | | | | 24 hr | 7 day | | | |
|---|---|---|---|---|---|---|---|---|---|---|
| | | | | Gel | Fusion | Viscosity | Viscosity | | | |
| | | | Hardness | Temp | Point | @ 10/s | @ 10/s | 4 h | 24 hr | 7 day |
| Formulation | PHR | Plasticizer | (A) | (° C.) | (° C.) | (cps) | (cps | Exudation | Exudation | Exudation |
| 42 | 50 | VikoFlex 5075 | 81 | 71.6 | 137.4 | 6602 | 5121 | 3 | 3 | 3 |
| 43 | 75 | VikoFlex 5075 | 64 | 79.6 | 142.8 | 1599 | 1664 | 3 | 3 | 3 |
| 44 | 100 | VikoFlex 5075 | 51 | 100.4 | 144.7 | 901 | 972 | 3 | 3 | 2 |
| 45 | 75 | Eastman 168 | 67 | 80.3 | 135 | 1101 | 1166 | 3 | 3 | 3 |
| 46 | 75 | Drapex 6.8 | 65 | 79 | 134.5 | 7189 | 6781 | 2 | 2 | 3 |
| 47 | 75 | 60/40 | 59 | 64.1 | 114.4 | 1063 | 1125 | 2 | 1 | 0 |
| | | DBT/VF | | | | | | | | |
| | | 5075 | | | | | | | | |
| 48 | 75 | 60/40 | 59 | 63.8 | 113 | 1889 | 201 | 1 | 1 | 0 |
| | | DBT/Drapex | | | | | | | | |
| | | 6.8 | | | | | | | | |
| 49 | 100 | 60/40 | 50 | 69.2 | 117.2 | 504 | 558 | 1 | 1 | 0 |
| | | DBT/VF | | | | | | | | |
| | | 5075 | | | | | | | | |
| 50 | 75 | 40/60 | 61 | 68.7 | 123.5 | 1277 | 1190 | 3 | 2 | 0 |
| | | DBT/VF | | | | | | | | |
| | | 5075 | | | | | | | | |

### Gel Point and Fusion Peak Temperature

The gel point and fusion peak temperature of plastisols containing 75 phr of DOTP, Drapex® 6.8 and Vikoflex® 5075 are listed in Table 17. As seen in previous examples both DOTP and Drapex® 6.8 formulations give similar gel point and fusion temperature while the formulation containing Vikoflex® 5075 has the same gel point but it's fusion temperature is about 8-10° C. higher. The formulation containing a 60/40 blend of DBT/Vikoflex® 5075 at 75 phr has a gel point and fusion temperature a good 8-16° C. lower than DOTP showing that a DBT can be utilized to lower the gel point and fusion temperature.

### Durometer a Hardness

Durometer hardness (A) of buttons made from plastisols containing 75 phr of DOTP, Drapex® 6.8 and Vikoflex® 5075 are listed in Table 17. As seen in previous examples Drapex® 6.8 is more efficient than DOTP. Vikoflex® 5075 is also more efficient than DOTP. Blends of DBT/Vikkoflex 5075 are more efficient than Vikkoflex 5075 itself showing that DBT is an efficient plasticizer.

### Loop Spew Testing

Loop spew testing conducted on films made from plastisols containing 75 phr of DOTP, Drapex® 6.8 and Vikoflex® 5075 are listed in Table 17. All three of these formulations lead to films with significant exudation over time. Addition of DBT in all DBT/Epoxidized oil blends show a great improvement in compatibility with PVC leading to 0 exudation at day 7.

### Neat Plasticizer Viscosity

The plasticizers in this study were analyzed for viscosity using an Anton Paar Rheometer.

TABLE 18
Dynamic viscosity of neat plasticizers at 25° C.

| | Temperature | Dynamic Viscosity |
|---|---|---|
| Neat plasticizer | [° C.] | [mPa · s] |
| DiBP | 25 | 30.3 |
| DBP | 25 | 15.9 |
| VP-953 | 25 | 70.5 |
| DBT | 25 | 16.4 |
| 60/40 DiBP/ESO | 25 | 91.0 |
| 60/40 DBT/ESO | 25 | 58.9 |
| 40/60 DBT/ESO | 25 | 107.0 |
| ESO* | 25 | 326.0 |

*ESO = Drapex ® 6.8

The viscosity values for each plasticizer is listed in Table 18. The viscosity of DBP of 16 cP is almost twice as low in viscosity compared to DiBP having a viscosity of 30 cP. DBP and its terephthalate isomer DBT have the lowest viscosity of the plasticizers studied having a viscosity of 16 cP. Benzoflex™ VP-953 has a viscosity of 70 cP which is higher than DBT and DiBP. As expected ESO having a viscosity of 326 cP has the highest viscosity of all the neat plasticizers studied. Blending any of the plasticizers studied into ESO at the same ratio will lead to a reduction in viscosity for the blend. Of these two 60/40 blends the lowest viscosity of 59 cP was achieved with the 60/40 DBT/ESO blend. The 60/40 DiBP/ESO blend had a viscosity of 91 cP. For comparison purposes, DOTP which is widely used commercially as a general purpose plasticizer has a viscosity of 66 cP at 25° C. The ability of DBT to lower the viscosity of a DBT/ESO blend to a viscosity similar viscosity of DOTP will be very helpful to producers of plastisols where viscosity control can be very important. The 40/60 DBT/ESO blend has a viscosity of 107 cP. Lowering the viscosity from 326 cP down to 107 cP could be helpful to a plastisol formulator.

Neat plasticizer freezing point: Another important physical property of a plasticizer is its freezing point. Plasticizers that freeze at relatively high temperatures may require heated storage tanks and trace heated transfer lines. This is an added expense for any flexible PVC producer utilizing this plasticizer. A typical ESO having a % oxirane content of 7% has a pour point of 0° C. DBT has a freezing point of <20° C. This storage handling issue can be solved by using blends of DBT and ESO. When mixing these two compounds together one is able to reduce the freezing point below that of either individual component. In our testing shown in Table 19, ESO was found to freeze at 7.5° C. DBT was found to freeze when placed in a bath set at 0° C. and based on literature should freeze at even higher temperatures. Blends of DBT and ESO were found to freeze below 0° C. An optimum freezing suppression was found to occur with a 60/40 blend of DBT/ESO which was found to freeze at −11° C. Attempts were made to find blends that would freeze at lower temperatures. A 30/30/40 blend of DBT/Benzoflex™ 9-88/ESO did not freeze at −21° C., however, at these low temperatures this ternary blend was very viscous. The isomeric mixture of DPT has a much lower freezing point than DBT (based on n-butanol) and was found to freeze at −21° C. A 60/40 blend of DPT/ESO was found to have a freezing point of −18° C., however, at this low temperature this blend was very viscous.

TABLE 19
Freezing point determination of plasticizers

| | | 5° C. | 4° C. | 3° C. | 2° C. | 1° C. | 0° C. | −1° C. | −2° C. | −3° C. | −4° C. |
|---|---|---|---|---|---|---|---|---|---|---|---|
| Samples | 7.5° C. | Frozen (Y/N) | | | | | | | | | |
| 20/80 | ND | N | N | Y | Y | Y | Y | Y | Y | Y | Y |
| DBT/ESO | | | | | | | | | | | |
| 30/70 | ND | N | N | N | N | N | Y | Y | Y | Y | Y |
| DBT/ESO | | | | | | | | | | | |
| 40/60 | ND | N | N | N | N | N | Y | Y | Y | Y | Y |
| DBT/ESO | | | | | | | | | | | |
| 60/40 | ND | N | N | N | N | N | N | N | N | N | N |
| DBT/ESO | | | | | | | | | | | |
| 70/30 | ND | N | N | N | N | N | N | N | N | N | N |
| DBT/ESO | | | | | | | | | | | |
| DBT | ND | N | N | N | N | N | Y | Y | Y | Y | Y |
| 60/40 | ND | N | N | N | N | N | N | N | N | N | N |
| DPT/ESO | | | | | | | | | | | |
| DPT | ND | N | N | N | N | N | N | N | N | N | N |
| 30/30/40 | ND | N | N | N | N | N | N | N | N | N | N |
| DBT/9-88/ESO | | | | | | | | | | | |
| ESO | Y | Y | Y | Y | Y | Y | Y | Y | Y | Y | Y |

| | −5° C. | −6° C. | −7° C. | −8° C. | −9° C. | −10° C. | −11° C. | −12° C. | −13° C. |
|---|---|---|---|---|---|---|---|---|---|
| Samples | Frozen (Y/N) | | | | | | | | |
| 20/80 | Y | Y | Y | Y | Y | Y | Y | Y | Y |
| DBT/ESO | | | | | | | | | |
| 30/70 | Y | Y | Y | Y | Y | Y | Y | Y | Y |
| DBT/ESO | | | | | | | | | |
| 40/60 | Y | Y | Y | Y | Y | Y | Y | Y | Y |
| DBT/ESO | | | | | | | | | |
| 60/40 | N | N | N | N | N | N | Y | Y | Y |
| DBT/ESO | | | | | | (gel) | | | |
| 70/30 | Y | Y | Y | Y | Y | Y | Y | Y | Y |
| DBT/ESO | | | | | | | | | |
| DBT | Y | Y | Y | Y | Y | Y | Y | Y | Y |
| 60/40 | N | N | N | N | N | N | N | N | N |
| DPT/ESO | | | | | | (gel) | (gel) | (gel) | (gel) |
| DPT | N | N | N | N | N | N | N | N | N |
| 30/30/40 | N | N | N | N | N | N | N | N | N |
| DBT/9-88/ESO | | | | | | (gel) | (gel) | (gel) | (gel) |
| ESO | Y | Y | Y | Y | Y | Y | Y | Y | Y |

ND Not determined

Comparison chart showing desired properties: Compared to existing non-phthalate sustainable plasticizers, the proposed technical solution yields a plasticizer composition having a lower freezing point, lower viscosity, and relatively low volatility. This novel blend of plasticizers in PVC compositions provide better efficiency, better plasticizer compatibility and reduced dry times in PVC formulations. Table 20 compares a set of plasticizers to a set of desired properties. It can see that one cannot get the desired properties with ESO alone or any of the other individual plasticizer listed. We show one example of a plasticizer blend composition where we are able to meet all desired properties.

TABLE 20
Comparison chart of properties for selected plasticizers

| | Properties | | | | | |
|---|---|---|---|---|---|---|
| | | | | | | VOC <4 |
| | | Dry | Efficiency^{β} | Compatibility^{β} | Freeze | Weight % |
| | Non- | time <3 | Durometer A | Loop Spew = | Point <0° | (EPA |
| Plasticizer | Phthalate | min | Hardness <65 A | 0 at day 7 | C. | Method 24) |
| ESO | Yes | No | No | No | No | Yes |
| DiBP | No | Yes* | Yes* | Yes | Yes* | No |
| DBT | Yes | Yes* | Yes* | Yes | No | No |
| DBP | No | Yes* | Yes* | Yes | Yes* | No |
| VP953 | Yes | Yes* | ND | ND | No* | Yes |
| DOTP | Yes | No | No | No | Yes* | Yes |
| 60/40 | No | Yes | No | Yes | Yes* | No |
| DiBP/ESO | | | | | | |
| 60/40 | Yes | Yes | Yes | Yes | Yes | Yes |
| DBT/ESO | | | | | | |
| 60/40 | Yes | Yes* | No | No | Yes* | Yes |
| VP953/ESO | | | | | | |
| 40/60 | Yes | Yes | Yes | Yes | No | Yes |
| DBT/ESO | | | | | | |
| 60/40 | Yes | Yes | ND | ND | Yes | Yes* |
| DPT/ESO | | | | | | |

*Expected but not tested
^{β}Both Efficiency and Compatibility are for unfilled formulations containing 75 phr of plasticizer in dry blend formulations.

Based on the examples provided herein, although not tested, it is expected that a 60/40 DPT/ESO would also have all of the desired properties shown in Table 20 as shown for a 60/40 DBT/ESO blend.

### Migration Occurring on Surface of ESO Only PVC Compositions:

Films made from Formulations 14, 8 and 16 containing 50 phr, 75 phr and 100 phr of Epoxidized Soybean Oil, specifically Drapex 6.8, were clear in appearance. However, after about 6 months a white powder began to appear on the surface of these films due to migration of some part of the ESO composition. Films made from Formulations 15, 11 and 17 containing 50 phr, 75 phr and 100 phr of a 60/40 DBT/ESO blend remained clear in appearance and no white powder formed on the surface even after 1 full year. This example shows that DBT improves the compatibility of the epoxidized soybean oil in the PVC matric preventing the formation of unwanted white powder.

An additional consideration is that ESO is bio based, and can be combines with other bio based and/or recycled components.

The invention has been described in detail with reference to the embodiments disclosed herein, but it will be understood that variations and modifications can be effected within the spirit and scope of the invention.

1. A plasticizer composition comprising:
a) at least one terephthalate diester of a C₃-C₅ linear or branched alcohol; and
b) an epoxidized oil.

2. The plasticizer composition of claim 1, where the weight ratio of said terephthalate diester to said epoxidized oil is from 90:10 to 10:90.

3. The plasticizer composition of claim 1 wherein the weight ratio of said terephthalate diester to said epoxidized oil is from 80:20 to 20:80.

4. The plasticizer composition of claim 1 wherein the weight ratio of said terephthalate diester to said epoxidized oil is from 70:30 to 30:70.

5. The plasticizer composition of claim 1 wherein the weight ratio of said terephthalate diester to said epoxidized oil is from 60:40 to 40:60.

6. The plasticizer composition of claim 1 wherein said epoxidized oil has an oxirane content of about 4-10%.

7. The plasticizer composition of claim 6 wherein said epoxidized oil has an oxirane content of about 4-9%.

8. The plasticizer composition of claim 1 wherein said epoxidized oil is epoxidized soybean oil, epoxidized linseed oil, epoxidized castor oil, epoxidized palm oil, epoxidized tall oil, epoxidized linoleate, epoxidized oleate, epoxidized stearate, epoxidized propylene glycol dioleate and mixtures thereof.

9. The plasticizer composition of claim 1 wherein said terephthalate diester is, dibutyl terephthalate, diisobutyl terephthalate, dipentyl terephthalate, diisopentyl terephthalate, dipropyl terephthalate, diisopropyl terephthalate and mixtures thereof.

10. A polyvinyl chloride (PVC) composition comprising:
a) a PVC resin; and
b) a plasticizer composition, wherein said plasticizer composition is a blend comprising:
i) at least one terephthalate diester of a C₃-C₅ linear or branched alcohol or at least one dibenzoate ester; and
ii) an epoxidized oil.

11. The PVC composition of claim 10, where the weight ratio of said terephthalate diester to said epoxidized oil is from 90:10 to 10:90.

12. The PVC composition of claim 10, wherein the weight ratio of said terephthalate diester to said epoxidized oil is from 80:20 to 20:80.

13. The PVC composition of claim 10, wherein the weight ratio of said terephthalate diester to said epoxidized oil is from 70:30 to 30:70.

14. The PVC composition of claim 10, wherein the weight ratio of said terephthalate diester to said epoxidized oil is from 60:40 to 40:60.

15. A plasticizer composition comprising:
a) a dibenzoate ester; and
b) an epoxidized oil.

16. The plasticizer composition of claim 15 wherein the weight ratio of dibenzoate ester to epoxidized oil is from 90:10 to 10:90.

17. The PVC composition of claim 10 wherein said dibenzoate ester is selected from the group consisting of dipropylene glycol dibenzoates, diethylene glycol dibenzoates and triethylene glycol dibenzoates and mixtures thereof.

18. A PVC composition of claim 10 wherein said PVC resin is poly vinyl chloride, polyvinyl chloride co vinyl acetate, polyvinyl chloride co vinyl acrylate or mixtures thereof.
